(19) United States
(12) Patent Application Publication
(10) Pub. No.: US 2024/0300093 A1
(43) Pub. Date: Sep. 12, 2024

(54) SENSOR DEVICE AND ROBOTIC APPARATUS

(71) Applicant: SONY GROUP CORPORATION, TOKYO (JP)

(72) Inventors: KEN KOBAYASHI, TOKYO (JP); YOSHIAKI SAKAKURA, TOKYO (JP); KEI TSUKAMOTO, TOKYO (JP); TETSURO GOTO, TOKYO (JP)

(21) Appl. No.: 18/550,113

(22) PCT Filed: Jan. 24, 2022
(86) PCT No.: PCT/JP2022/002330

§ 371 Date: Sep. 11, 2023

(30) Foreign Application Priority Data
Mar. 17, 2021 (JP) 2021-043152

(51) Int. Cl. B25J 9/16; B25J 13/08

(52) U.S. Cl. CPC B25J 9/1612; B25J 13/082; G05B 2219/39001

(57) ABSTRACT

A sensor device according to an embodiment of the present disclosure includes a first pressure distribution sensor disposed in contact with a first support, and a second pressure distribution sensor disposed in contact with a second support. A center position of a pressure distribution to be detected due to gripping of an object-to-be-gripped based on when the object-to-be-gripped in a placed state is gripped by the first support and the second support is set to a first center position. In addition, a center position of a pressure distribution to be detected due to gripping of the object-to-be-gripped based on when the object-to-be-gripped is gripped and lifted by the first support and the second support is set to a second center position. In this case, respective shift amounts of the first pressure distribution sensor and second pressure distribution sensor are different from each other. Each of the shift amounts is a difference between the first center position and the second center position.

### TECHNICAL FIELD

The present disclosure relates to a sensor device, and a robotic apparatus including such a sensor device.

### BACKGROUND ART

In recent years, robotic automation of work has been studied in various situations with a decrease in the workforce. Accordingly, a sensor device that detects a force acting on a contact region of an object on a surface of a robotic device by being mounted on the surface of the robotic device has been proposed.

### CITATION LIST

### Patent Literature

PTL 1: Japanese Unexamined Patent Application Publication No. 2009-199221

### SUMMARY OF THE INVENTION

In the field of robotics, a sensor device having high sensitivity is desired. It is therefore desirable to provide a sensor device having high sensitivity and a robotic apparatus including such a sensor device.

A sensor device according to an embodiment of the present disclosure includes a first pressure distribution sensor disposed in contact with a first support, and a second pressure distribution sensor disposed in contact with a second support. A center position of a pressure distribution to be detected due to gripping of an object-to-be-gripped based on when the object-to-be-gripped in a placed state is gripped by the first support and the second support is set to a first center position. In addition, a center position of a pressure distribution to be detected due to gripping of the object-to-be-gripped based on when the object-to-be-gripped is gripped and lifted by the first support and the second support is set to a second center position. In this case, respective shift amounts of the first pressure distribution sensor and second pressure distribution sensor are different from each other. Each of the shift amounts is a difference between the first center position and the second center position.

A first robotic apparatus according to an embodiment of the present disclosure includes a robot hand part, a driver that drives the robot hand part, a sensor device provided in contact with the robot hand part, and a signal processor that processes a detection signal of the sensor device. The robot hand part includes a plurality of end parts configured to grip an object-to-be-gripped by being driven by the driver. The sensor device includes a first pressure distribution sensor and a second pressure distribution sensor. The first pressure distribution sensor is disposed in contact with a first end part out of the plurality of end parts, and detects an in-plane pressure distribution. The second pressure distribution sensor is disposed in contact with a second end part out of the plurality of end parts, and detects an in-plane pressure distribution. A center position of a pressure distribution to be detected due to gripping of the object-to-be-gripped based on when the object-to-be-gripped in a placed state is gripped by the first end part and the second end part is set to a first center position. In addition, a center position of a pressure distribution to be detected due to gripping of the object-to-be-gripped based on when the object-to-be-gripped is gripped and lifted by the first end part and the second end part is set to a second center position. In this case, respective shift amounts of the first pressure distribution sensor and second pressure distribution sensor are different from each other. Each of the shift amounts is a difference between the first center position and the second center position.

A second robotic apparatus according to an embodiment of the present disclosure includes a robot hand part, a driver that drives the robot hand part, a sensor device provided in contact with the robot hand part, and a signal processor that processes a detection signal of the sensor device. The robot hand part includes a plurality of end parts configured to grip an object-to-be-gripped by being driven by the driver. The sensor device includes a stack in which a first pressure distribution sensor that detects an in-plane pressure distribution, a viscoelastic layer that deforms by an external load, and a second pressure distribution sensor that detects an in-plane pressure distribution are stacked in this order on a first end part out of plurality of end parts. A center position of a pressure distribution to be detected due to gripping of the object-to-be-gripped based on when the object-to-be-gripped in a placed state is gripped by the plurality of end parts is set to a first center position. In addition, a center position of a pressure distribution to be detected due to gripping of the object-to-be-gripped based on when the object-to-be-gripped is gripped and lifted by the plurality of end parts is set to a second center position. In this case, respective shift amounts of the first pressure distribution sensor and second pressure distribution sensor are different from each other. Each of the shift amounts is a difference between the first center position and the second center position.

According to the sensor device of the embodiment of the present disclosure, the first robotic apparatus of the embodiment of the present disclosure, and the second robotic apparatus of the embodiment of the present disclosure, the respective shift amounts of the first pressure distribution sensor and the second pressure distribution sensor are different from each other. Each of the shift amounts is the difference between the first center position and the second center position. This makes it possible to derive a shear force on the basis of first pressure distribution data obtained from the first pressure distribution sensor and second pressure distribution data obtained from the second pressure distribution sensor. As a result, it is possible to determine whether or not it is possible to hold the object-to-be-gripped without slipping on the basis of a magnitude of the shear force.

### BRIEF DESCRIPTION OF DRAWINGS

FIG. 1 is a diagram illustrating a functional block example of a robotic apparatus according to an embodiment of the present disclosure.

FIG. 2 is a diagram illustrating a cross-sectional configuration example of a sensor element of FIG. 1.

FIG. 3 is a diagram illustrating a condition in which an object-to-be-gripped in a placed state is gripped by a robot hand part of FIG. 2.

FIG. 4 is a diagram illustrating a condition in which the object-to-be-gripped is gripped and lifted by the robot hand part of FIG. 2.

FIG. 5(A) is a diagram illustrating an example of a pressure distribution to be obtained by the sensor element of FIG. 3. FIG. 5(B) is a diagram illustrating an example of a pressure distribution to be obtained by the sensor element of FIG. 4.

FIG. 6 is a diagram illustrating a cross-sectional configuration example of a sensor element according to a comparative example.

FIG. 7(A) is a diagram illustrating an example of a pressure distribution to be obtained in a case where the sensor element of FIG. 6 is applied to the sensor element of FIG. 3. FIG. 7(B) is a diagram illustrating an example of a pressure distribution to be obtained in a case where the sensor element of FIG. 6 is applied to the sensor element of FIG. 4.

FIG. 8(A) is a diagram illustrating an example of a relationship between a pressure and a pressure sensitivity. FIG. 8(B) is a diagram illustrating an example of a relationship between a pressing force and a central coordinate.

FIG. 9(A) is a diagram illustrating an example of a relationship between a pressure and a pressure sensitivity. FIG. 9(B) is a diagram illustrating an example of a relationship between a pressing force and a central coordinate.

FIG. 10 is a diagram illustrating an example of an operation procedure in the robotic apparatus of FIG. 1.

FIG. 11 is a diagram illustrating an example of an operation procedure following FIG. 10.

FIG. 12 is a diagram illustrating a modification example of a cross-sectional configuration of an end portion of the robot hand part of FIG. 1.

FIG. 13 is a diagram illustrating a modification example of the cross-sectional configuration of the end portion of the robot hand part of FIG. 1.

FIG. 14 is a diagram illustrating a modification example of the cross-sectional configuration of the end portion of the robot hand part of FIG. 1.

FIG. 15 is a diagram illustrating a modification example of the cross-sectional configuration of the end portion of the robot hand part of FIG. 1.

FIG. 16 is a diagram illustrating a modification example of the cross-sectional configuration of the end portion of the robot hand part of FIG. 1.

FIG. 17 is a diagram illustrating a modification example of the cross-sectional configuration of the end portion of the robot hand part of FIG. 1.

FIG. 18 is a diagram illustrating a modification example of the cross-sectional configuration of the end portion of the robot hand part of FIG. 1.

FIG. 19 is a diagram illustrating a modification example of the cross-sectional configuration of the end portion of the robot hand part of FIG. 1.

FIG. 20 is a diagram illustrating a modification example of the cross-sectional configuration of the end portion of the robot hand part of FIG. 1.

### MODES FOR CARRYING OUT THE INVENTION

In the following, some embodiments of the present disclosure are described in detail with reference to the drawings.

### 1. EMBODIMENT

### Configuration

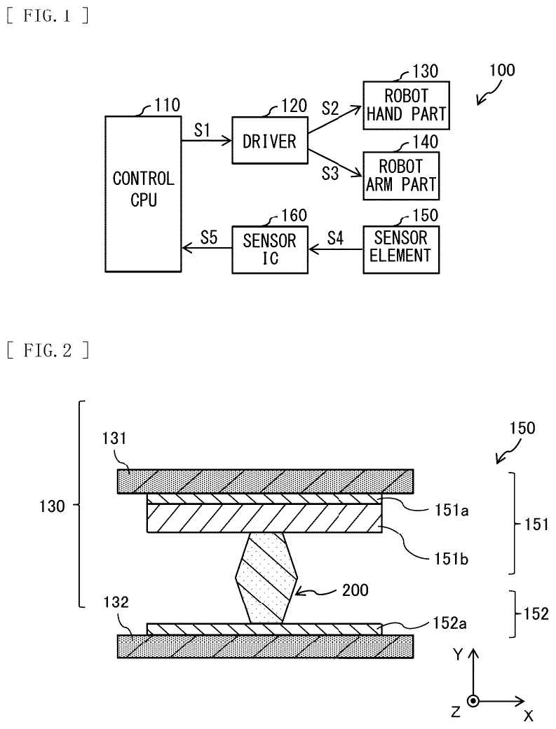

A robotic apparatus 100 according to an embodiment of the present disclosure will be described. FIG. 1 illustrates a functional block example of the robotic apparatus 100 according to the present embodiment. The robotic apparatus 100 includes a control CPU (Central Processing Unit) 110, a driver 120, a robot hand part 130, a robot arm part 140, a sensor element 150 and a sensor IC (integrated circuit) 160.

The driver 120 drives the robot hand part 130 and the robot arm part 140. The robot hand part 130 includes a plurality of end parts. The robot hand part 130 displaces the plurality of end parts on the basis of a control signal S2 to be inputted from the driver 120 to thereby grip an object-to-be-gripped or release the gripped object-to-be-gripped. The robot hand part 130 is coupled to an end of the robot arm part 140. The robot arm part 140 displaces a position of the robot hand part 130 coupled to the end on the basis of a control signal S3 to be inputted from the driver 120.

The sensor element 150 is provided in contact with the robot hand part 130. The sensor element 150 detects, from the object-to-be-gripped, a pressure distribution applied to each of at least two end parts of the plurality of end parts due to gripping of the object-to-be-gripped by the robot hand part 130. The sensor element 150 outputs a plurality of pieces of pressure distribution data S4 obtained by the detection to the sensor IC 160. The sensor IC 160 calculates a pressure at a center position of the pressure distribution and a shear force to be applied from the object-to-be-gripped on the basis of the plurality of pieces of pressure distribution data inputted from the sensor element 150. The sensor IC 160 outputs the calculated grip force data and shear force (shear force data) as sensor data S5 to the control CPU 110. The control CPU 110 uses the sensor data S5 inputted from the sensor IC 160 to generate a control signal S1 necessary for driving the robot hand part 130 and the robot arm part 140, and outputs the generated control signal S1 to the driver 120.

FIG. 2 illustrates a cross-sectional configuration example of the sensor element 150. FIG. 2 exemplifies a configuration of a horizontal cross section of the robot hand part 130, the sensor element 150, and an object-to-be-gripped 200. FIG. 2 exemplifies a case where the robot hand part 130 is provided with two end parts (a first end part 131 and a second end part 132).

In the present embodiment, the first end part 131 and the second end part 132 are opposed to each other with a predetermined gap therebetween, and a size of the gap between the first end part 131 and the second end part 132 is displaced by being driven by the driver 120. In a case where the object-to-be-gripped 200 is disposed in the gap between the first end part 131 and the second end part 132, the gap between the first end part 131 and the second end part 132 is narrowed, thereby gripping the object-to-be-gripped 200 by the first end part 131 and the second end part 132. In a case where the first end part 131 and the second end part 132 grip the object-to-be-gripped 200, the gap between the first end part 131 and the second end part 132 widens, thereby releasing the object-to-be-gripped 200 from the first end part 131 and the second end part 132.

The sensor element 150 includes a pressure distribution sensor 151 and a pressure distribution sensor 152. The pressure distribution sensor 151 is disposed in contact with a surface, of the first end part 131, on a side of the second end part 132. The pressure distribution sensor 151 is fixed to the surface of the first end part 131 via, for example, an adhesive layer. The pressure distribution sensor 152 is disposed in contact with a surface, of the second end part 132, on a side of the first end part 131. The pressure distribution sensor 152 is fixed to the surface of the second end part 132 via, for example, an adhesive layer.

The pressure distribution sensor 151 includes a pressure sensor layer 151a and a viscoelastic layer 151b. The pressure sensor layer 151a detects an in-plane pressure distribution of an externally applied load via the viscoelastic layer 151b. The pressure sensor layer 151a outputs the pressure distribution data obtained by the detection to the sensor IC 160. The pressure sensor layer 151a includes, for example, a capacitive pressure distribution sensor, a resistance pressure distribution sensor, or the like.

The viscoelastic layer 151b is provided in contact with a surface, of the pressure sensor layer 151a, on a side opposite to the first end part 131. The viscoelastic layer 151b includes a material that deforms by an external load. The viscoelastic layer 151b includes a viscoelastic material having a viscoelastic characteristic such as a silicone gel, a urethane gel, or an acrylic gel, for example. The viscoelastic layer 151b may include, for example, a low-hardness rubber. The viscoelastic layer 151b has a thickness of, for example, less than or equal to 1 mm. The viscoelastic layer 151b has a hardness of, for example, less than or equal to 10° in terms of Durometer A (Shore A). The penetration of the viscoelastic layer 151b is, for example, greater than or equal to 1 in the penetration test method standardized by JIS K2207.

The pressure distribution sensor 152 includes a pressure sensor layer 152a. In the present embodiment, the pressure distribution sensor 152 is provided with no viscoelastic layer like the viscoelastic layer 151b. The pressure sensor layer 152a detects an in-plane pressure distribution of an externally applied load. The pressure sensor layer 152a outputs the pressure distribution data obtained by the detection to the sensor IC 160. The pressure sensor layer 152a includes, for example, a capacitive pressure distribution sensor, a resistance pressure distribution sensor, or the like.

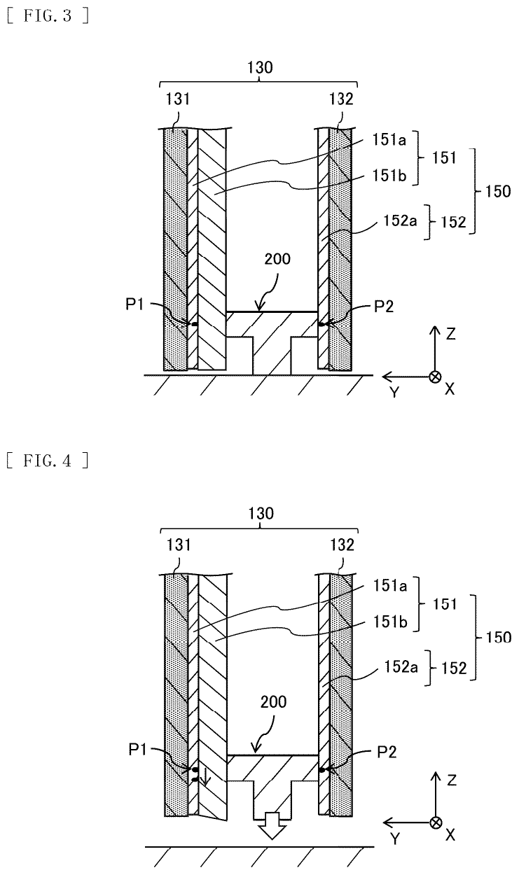

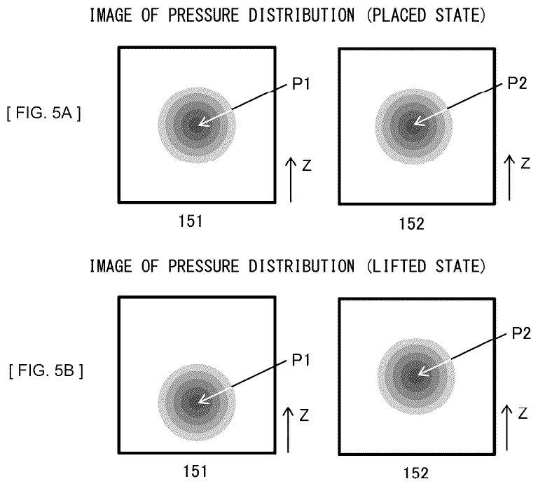

FIG. 3 illustrates a condition in which the object-to-be-gripped 200 in a placed state is gripped by the robot hand part 130. FIG. 3 exemplifies a configuration of a vertical cross section the robot hand part 130, the sensor element 150, and the object-to-be-gripped 200. FIG. 4 illustrates a condition in which the object-to-be-gripped 200 is gripped and lifted by the robot hand part 130. FIG. 4 exemplifies a configuration of the vertical cross section the robot hand part 130, the sensor element 150, and the object-to-be-gripped 200.

In a case where the object-to-be-gripped 200 in the placed state is gripped by the robot hand part 130, a load is applied to the pressure distribution sensors 151 and 152 from the object-to-be-gripped 200. When the load is applied from the object-to-be-gripped 200 due to gripping of the object-to-be-gripped 200, the pressure distribution sensors 151 and 152 each detect a pressure distribution corresponding to the applied load (for example, FIG. 5(A)). In this case, a center position of the pressure distribution to be detected by the pressure distribution sensor 151 is set to P1, and a center position of the pressure distribution to be detected by the pressure distribution sensor 152 is set to P2. The center position P1 is, for example, a position corresponding to a peak value in the pressure distribution detected by the pressure distribution sensor 151. The center position P2 is, for example, a position corresponding to a peak value in the pressure distribution detected by the pressure distribution sensor 152.

Further, also in a case where the object-to-be-gripped 200 is gripped and lifted by the robot hand part 130, a load is applied to the pressure distribution sensors 151 and 152 from the object-to-be-gripped 200. The pressure distribution sensors 151 and 152 each detect a pressure distribution corresponding to the load applied from the object-to-be-gripped 200 based on when the object-to-be-gripped 200 is in a gripped state (for example, FIG. 5(B)). At this time, the object-to-be-gripped 200 applies a downward stress to each of the pressure distribution sensors 151 and 152 due to its own weight. At this time, the viscoelastic layer 151b is pulled downward by the stress and deformed. As a result, the center position P1 of the pressure distribution to be detected by the pressure distribution sensor 151 is shifted downward. At this time, a shear force generated in the pressure distribution sensor 151 by the object-to-be-gripped 200 (hereinafter, referred to as “shear force F1”) may be derived on the basis of the shift amount of the center position P1 of the pressure distribution to be detected by the pressure distribution sensor 151. In contrast, the pressure distribution sensor 152 is provided with no viscoelastic layer like the viscoelastic layer 151b, and thus, the center position P2 of the pressure distribution to be detected by the pressure distribution sensor 152 does not change or hardly changes. At this time, a shear force generated in the pressure distribution sensor 152 by the object-to-be-gripped 200 (hereinafter, referred to as “shear force F2”) may be derived on the basis of the shift amount of the center position P2 of the pressure distribution to be detected by the pressure distribution sensor 152. The shift amount of the center position P1 and the shift amount of the center position P2 are different from each other. The shift amount of the center position P1 is greater than the shift amount of the center position P2. The shear force F1 and the shear force F2 are different from each other. The shear force F1 is greater than the shear force F2.

It is assumed that, when the object-to-be-gripped 200 in the placed state is gripped by the robot hand part 130, a correspondence relationship between the center position P1 of the pressure distribution to be detected by the pressure distribution sensor 151 and the center position P2 of the pressure distribution to be detected by the pressure distribution sensor 152 is known. In addition, it is assumed that there is no or little change between: the center position P2 based on when the object-to-be-gripped 200 in the placed state is gripped by the robot hand part 130; and the center position P2 based on when the object-to-be-gripped 200 is gripped and lifted by the robot hand part 130. In this case, the shear force generated in the pressure distribution sensor 151 by the object-to-be-gripped 200 may be derived on the basis of the correspondence relationship and a difference (a shift amount) between the center position P1 of the pressure distribution to be detected by the pressure distribution sensor 151 and the center position P2 of the pressure distribution to be detected by the pressure distribution sensor 152 based on when the object-to-be-gripped 200 is gripped and lifted by the robot hand part 130.

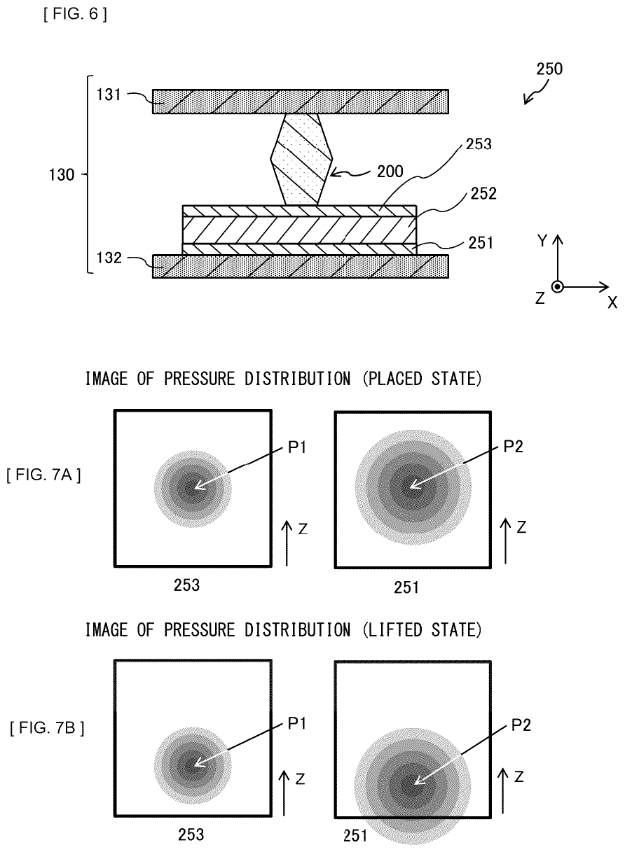

Here, a change in the pressure distribution in a case where the sensor element 150 is replaced with a sensor element 250 according to a comparative example will be described. As illustrated in FIG. 6, for example, the sensor element 250 is provided only on the surface of the second end part 132. The sensor element 250 has a stack in which a pressure sensor layer 251, a viscoelastic layer 252, and a pressure sensor layer 253 are stacked in this order on the surface of the second end part 132.

The pressure sensor layer 251 detects an in-plane pressure distribution. The pressure sensor layer 251 outputs the pressure distribution data obtained by the detection to the sensor IC 160. The pressure sensor layer 251 includes, for example, a capacitive pressure distribution sensor, a resistance pressure distribution sensor, or the like.

The viscoelastic layer 252 includes a material that deforms by an external load. The viscoelastic layer 252 includes a viscoelastic material having a viscoelastic characteristic such as a silicone gel, a urethane gel, or an acrylic gel, for example. The viscoelastic layer 252 may include, for example, a low-hardness rubber. The viscoelastic layer 252 has a thickness of, for example, less than or equal to 1 mm. The viscoelastic layer 252 has a hardness of, for example, less than or equal to 10° in terms of Durometer A (Shore A). The penetration of the viscoelastic layer 252 is, for example, greater than or equal to 1 in the penetration test method standardized by JIS K2207.

The pressure sensor layer 253 detects an in-plane pressure distribution. The pressure sensor layer 253 outputs the pressure distribution data obtained by the detection to the sensor IC 160. The pressure sensor layer 253 includes, for example, a capacitive pressure distribution sensor, a resistance pressure distribution sensor, or the like.

In a case where the object-to-be-gripped 200 in the placed state is gripped by the robot hand part 130, a load is applied to the pressure sensor layers 251 and 253 from the object-to-be-gripped 200. When the load is applied from the object-to-be-gripped 200 due to gripping of the object-to-be-gripped 200, the pressure sensor layers 251 and 253 each detect a pressure distribution corresponding to the applied load (for example, FIG. 7(A)). In this case, a center position of the pressure distribution to be detected by the pressure sensor layer 253 is set to P1, and a center position of the pressure distribution to be detected by the pressure sensor layer 251 is set to P2. The center position P1 is, for example, a position corresponding to a peak value in the pressure distribution detected by the pressure sensor layer 253. The center position P2 is, for example, a position corresponding to a peak value in the pressure distribution detected by the pressure sensor layer 251.

The load from the object-to-be-gripped 200 is applied to the pressure sensor layer 251 via the viscoelastic layer 252. Accordingly, the pressure distribution to be detected by the pressure sensor layer 251 is broader than the pressure distribution to be detected by the pressure sensor layer 253. Further, a value of a pressure at the center position P2 is smaller than a value of a pressure at the center position P1, and a sensitivity of the pressure sensor layer 251 is lower than a sensitivity of the pressure sensor layer 253.

Further, also in a case where the object-to-be-gripped 200 is gripped and lifted by the robot hand part 130, a load is applied to the pressure sensor layers 251 and 253 from the object-to-be-gripped 200. The pressure sensor layers 251 and 253 each detect a pressure distribution corresponding to the load applied from the object-to-be-gripped 200 based on when the object-to-be-gripped 200 is in a gripped state (for example, FIG. 7(B)). At this time, the object-to-be-gripped 200 applies a downward stress to each of the pressure sensor layers 251 and 253 due to its own weight. At this time, the viscoelastic layer 252 is pulled downward by the stress and deformed. As a result, the center position P2 of the pressure distribution to be detected by the pressure sensor layer 251 is shifted downward. In contrast, the pressure sensor layer 253 is directly in contact with the object-to-be-gripped 200, and thus, the center position P1 of the pressure distribution to be detected by the pressure sensor layer 253 does not change or hardly changes.

It is assumed that, when the object-to-be-gripped 200 in the placed state is gripped by the robot hand part 130, a correspondence relationship between the center position P1 of the pressure distribution to be detected by the pressure sensor layer 253 and the center position P2 of the pressure distribution to be detected by the pressure sensor layer 251 is known. In addition, it is assumed that there is no or little change between: the center position P1 based on when the object-to-be-gripped 200 in the placed state is gripped by the robot hand part 130; and the center position P1 based on when the object-to-be-gripped 200 is gripped and lifted by the robot hand part 130. In this case, the shear force generated in the sensor element 250 by the object-to-be-gripped 200 may be derived on the basis of the correspondence relationship and a difference (a shift amount) between the center position P1 of the pressure distribution to be detected by the pressure sensor layer 251 and the center position P2 of the pressure distribution to be detected by the pressure sensor layer 253 based on when the object-to-be-gripped 200 is gripped and lifted by the robot hand part 130.

When the center position P2 of the pressure distribution is shifted downward, a portion of the pressure distribution may be out of a detection range in the pressure sensor layer 251 (see the figure on the right side of FIG. 7(B)). In this case, it is difficult to accurately calculate the center position P2 of the pressure distribution from the pressure distribution obtained from the pressure sensor layer 251.

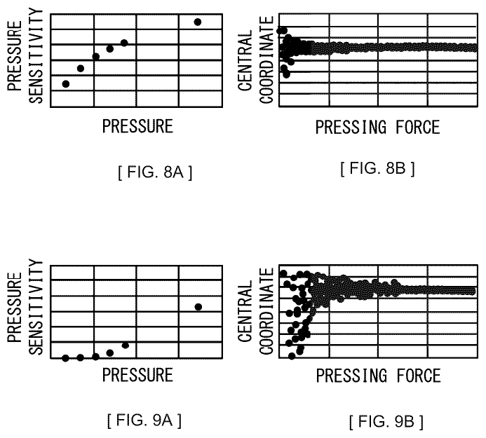

In the pressure distribution sensors 151 and 152 according to the present embodiment, for example, as illustrated in FIG. 8(A) and FIG. 8(B), a sensitivity to the pressure is high even if the pressure is low, and variation in the coordinates of the center position of the pressure distribution is small even if the pressure is low. In this case, a difference ΔP between the coordinates of the center position P1 and the coordinates of the center position P2 obtained when the object-to-be-gripped 200 is gripped and lifted by the robot hand part 130 corresponds to the shift amount of the center position P1. Accordingly, the control CPU 110 is able to accurately derive the shear force on the basis of the difference ΔP.

In the pressure sensor layer 253 according to the comparative example, for example, as illustrated in FIG. 8(A) and FIG. 8(B), the sensitivity to the pressure is high even if the pressure is low, and the variation in the coordinates of the center position of the pressure distribution is low even if the pressure is low. However, in the pressure sensor layer 251 according to the comparative example, for example, as illustrated in FIG. 9(A) and FIG. 8(B), the sensitivity to the pressure is low at low pressure, and the variation in the coordinates of the center position of the pressure distribution increases at low pressure. In this case, the difference AP between the coordinates of the center position P1 and the coordinates of the center position P2 obtained when the object-to-be-gripped 200 is gripped and lifted by the robot hand part 130 is likely to vary. Accordingly, in a case where the shear force is derived using the difference ΔP, the derived shear force is also likely to vary.

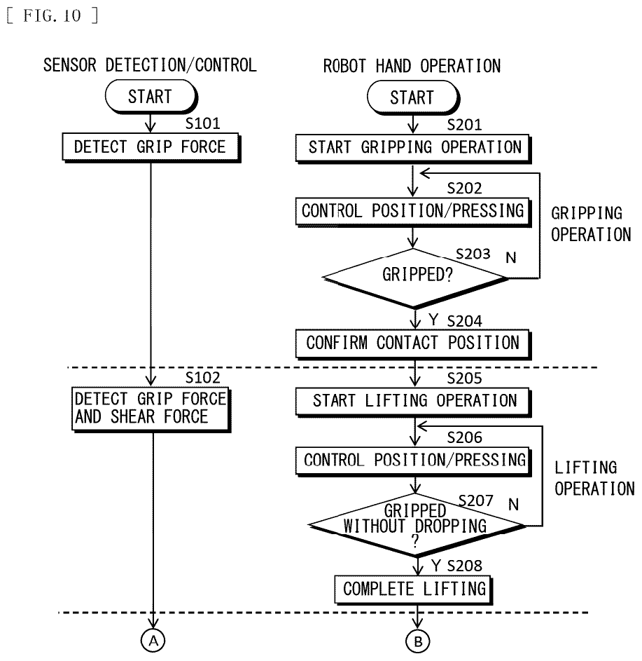

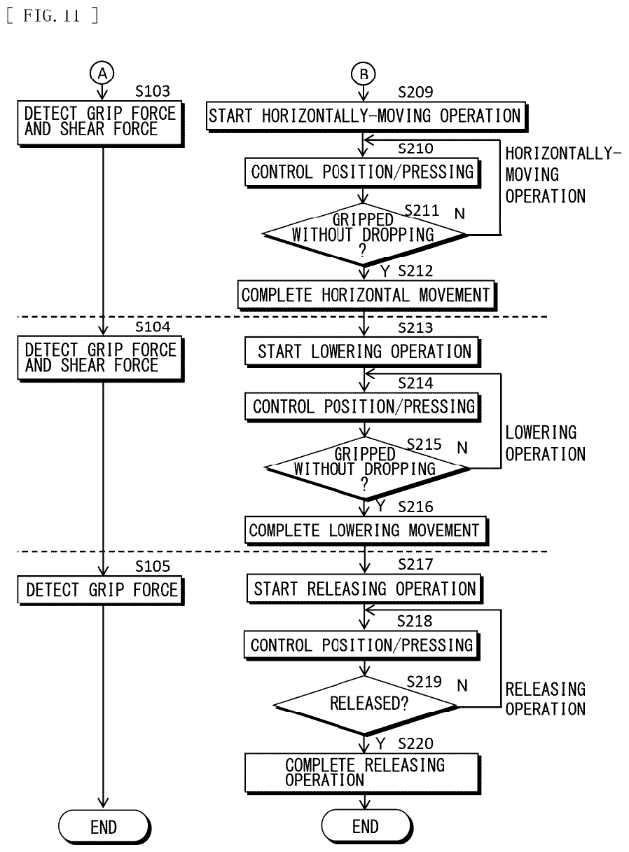

Next, an operation procedure in the robotic apparatus 100 will be described. FIG. 10 and FIG. 11 each illustrate an example of the operation procedure in the robotic apparatus 100. The control CPU 110 controls operations of the robot hand part 130 and the robot arm part 140 in the following order: a gripping operation, a lifting operation, a horizontally-moving operation, a lowering operation, and a releasing operation.

First, the control CPU 110 causes the robot hand part 130 and the robot arm part 140 to start the gripping operation via the driver 120 (step S201). At this time, the control CPU 110 instructs the sensor IC 160 to detect a grip force. The sensor IC 160 acquires two pieces of pressure distribution data from the sensor element 150, and calculates grip force data on the basis of the acquired two pieces of pressure distribution data. The sensor IC 160 outputs the calculated grip force data to the control CPU 110. The control CPU 110 acquires the grip force data from the sensor IC 160 (step S101).

The control CPU 110 controls, on the basis of the grip force data inputted from the sensor IC 160, a position of the plurality of end parts of the robot hand part 130 and the robot arm part 140 and pressing performed by the plurality of end parts of the robot arm part 140 on the object-to-be-gripped 200 (step S202). At this time, the control CPU 110 determines whether or not the plurality of end parts of the robot arm part 140 has gripped the object-to-be-gripped 200 (step S203). For example, if the grip force exceeds a predetermined target value, the control CPU 110 determines that the plurality of end parts of the robot arm part 140 has gripped the object-to-be-gripped 200, and confirms the position (a contact position) of the plurality of end parts of the robot arm part 140 (step S204).

Thereafter, the control CPU 110 causes the robot hand part 130 and the robot arm part 140 to start the lifting operation via the driver 120 (step S205). At this time, the control CPU 110 instructs the sensor IC 160 to detect the grip force and the shear force. The sensor IC 160 acquires two pieces of pressure distribution data from the sensor element 150, and calculates the grip force data and the shear force data on the basis of the acquired two pieces of pressure distribution data. For example, the sensor IC 160 calculates the above-described difference ΔP, and derives the shear force on the basis of the calculated difference ΔP. The sensor IC 160 outputs the calculated grip force data and shear force data to the control CPU 110. The control CPU 110 acquires the grip force data and the shear force data from the sensor IC 160 (step S102).

The control CPU 110 controls, on the basis of the grip force data and the shear force data inputted from the sensor IC 160, the position of the plurality of end parts of the robot hand part 130 and the robot arm part 140 and the pressing performed by the plurality of end parts of the robot arm part 140 on the object-to-be-gripped 200 (step S206). At this time, the control CPU 110 determines whether or not the plurality of end parts of the robot arm part 140 grips the object-to-be-gripped 200 without dropping it (step S207). The control CPU 110 determines that the plurality of end parts of the robot arm part 140 is likely to drop the object-to-be-gripped 200 if, for example, the shear force exceeds a predetermined target value (N in step S207). As a result, the control CPU 110 resets the pressing force of the plurality of end parts of the robot arm part 140 on the object-to-be-gripped 200 (step S206). In contrast, the control CPU 110 determines that the plurality of end parts of the robot arm part 140 is gripping the object-to-be-gripped 200 without dropping it if, for example, the shear force does not exceed the predetermined target value (Y in step S207). As a result, the control CPU 110 maintains the pressing force of the plurality of end parts of robot arm part 140 on the object-to-be-gripped 200. In this way, the lifting operation of the object-to-be-gripped 200 is completed (step S208).

Thereafter, the control CPU 110 causes the robot hand part 130 and the robot arm part 140 to start the horizontally-moving operation via the driver 120 (step S209). At this time, the control CPU 110 instructs the sensor IC 160 to detect the grip force and the shear force. The sensor IC 160 acquires two pieces of pressure distribution data from the sensor element 150, and calculates the grip force data and the shear force data on the basis of the acquired two pieces of pressure distribution data. The sensor IC 160 outputs the calculated grip force data and shear force data to the control CPU 110. The control CPU 110 acquires the grip force data and the shear force data from the sensor IC 160 (step S103).

The control CPU 110 controls, on the basis of the grip force data and the shear force data inputted from the sensor IC 160, the position of the plurality of end parts of the robot hand part 130 and the robot arm part 140 and the pressing performed by the plurality of end parts of the robot arm part 140 on the object-to-be-gripped 200 (step S210). At this time, the control CPU 110 determines whether or not the plurality of end parts of the robot arm part 140 grips the object-to-be-gripped 200 without dropping it (step S211). The control CPU 110 determines that the plurality of end parts of the robot arm part 140 is likely to drop the object-to-be-gripped 200 if, for example, the shear force exceeds the predetermined target value (N in step S211). As a result, the control CPU 110 resets the pressing force of the plurality of end parts of the robot arm part 140 on the object-to-be-gripped 200 (step S210). In contrast, the control CPU 110 determines that the plurality of end parts of the robot arm part 140 is gripping the object-to-be-gripped 200 without dropping it if, for example, the shear force does not exceed the predetermined target value (Y in step S211). As a result, the control CPU 110 maintains the pressing force of the plurality of end parts of robot arm part 140 on the object-to-be-gripped 200. In this way, the horizontally-moving operation of the object-to-be-gripped 200 is completed (step S212).

Thereafter, the control CPU 110 causes the robot hand part 130 and the robot arm part 140 to start the lowering operation via the driver 120 (step S213). At this time, the control CPU 110 instructs the sensor IC 160 to detect the grip force and the shear force. The sensor IC 160 acquires two pieces of pressure distribution data from the sensor element 150, and calculates the grip force data and the shear force data on the basis of the acquired two pieces of pressure distribution data. The sensor IC 160 outputs the calculated grip force data and shear force data to the control CPU 110. The control CPU 110 acquires the grip force data and the shear force data from the sensor IC 160 (step S104).

The control CPU 110 controls, on the basis of the grip force data and the shear force data inputted from the sensor IC 160, the position of the plurality of end parts of the robot hand part 130 and the robot arm part 140 and the pressing performed by the plurality of end parts of the robot arm part 140 on the object-to-be-gripped 200 (step S214). At this time, the control CPU 110 determines whether or not the plurality of end parts of the robot arm part 140 grips the object-to-be-gripped 200 without dropping it (step S215). The control CPU 110 determines that the plurality of end parts of the robot arm part 140 is likely to drop the object-to-be-gripped 200 if, for example, the shear force exceeds the predetermined target value (N in step S215). As a result, the control CPU 110 resets the pressing force of the plurality of end parts of the robot arm part 140 on the object-to-be-gripped 200 (step S214). In contrast, the control CPU 110 determines that the plurality of end parts of the robot arm part 140 is gripping the object-to-be-gripped 200 without dropping it if, for example, the shear force does not exceed the predetermined target value (Y in step S215). As a result, the control CPU 110 maintains the pressing force of the plurality of end parts of robot arm part 140 on the object-to-be-gripped 200. In this way, the lowering operation of the object-to-be-gripped 200 is completed (step S216).

Thereafter, the control CPU 110 causes the robot hand part 130 and the robot arm part 140 to start the releasing operation via the driver 120 (step S217). At this time, the control CPU 110 instructs the sensor IC 160 to detect the grip force. The sensor IC 160 acquires two pieces of pressure distribution data from the sensor element 150, and calculates the grip force data on the basis of the acquired two pieces of pressure distribution data. The sensor IC 160 outputs the calculated grip force data to the control CPU 110. The control CPU 110 acquires the grip force data from the sensor IC 160 (step S106).

The control CPU 110 controls, on the basis of the grip force data inputted from the sensor IC 160, the position of the plurality of end parts of the robot hand part 130 and the robot arm part 140 and the pressing performed by the plurality of end parts of the robot arm part 140 on the object-to-be-gripped 200 (step S218). At this time, the control CPU 110 determines whether or not the plurality of end parts of the robot arm part 140 has released the object-to-be-gripped 200 (step S219). The control CPU 110 determines that the plurality of end parts of the robot arm part 140 has released the object-to-be-gripped 200 if, for example, the grip force falls below the predetermined target value (Y in step S219). In contrast, the control CPU 110 determines that the plurality of end parts of the robot arm part 140 has not yet released the object-to-be-gripped 200 if, for example, the shear force exceeds the predetermined target value (Y in step S215). At this time, the control CPU 110 resets the pressing force of the plurality of end parts of the robot arm part 140 on the object-to-be-gripped 200 (step S218). In this way, the releasing operation of the object-to-be-gripped 200 is completed (step S220).

### Effects

Next, effects of the robotic apparatus 100 according to the present embodiment will be described.

In the present embodiment, the shift amount of the center position P1 and the shift amount of the center position P2 based on when the object-to-be-gripped 200 is lifted by the robot hand part 130 are different from each other. This makes it possible to derive the shear force on the basis of, for example, the pressure distribution data obtained from the pressure distribution sensor 151 and the pressure distribution data obtained from the pressure distribution sensor 152. As a result, it is possible to determine whether or not it is possible to hold the object-to-be-gripped 200 without slipping on the basis of a magnitude of the shear force. Accordingly, it is possible to achieve the sensor element 150 having high sensitivity.

In the present embodiment, the pressure distribution sensor 151 includes the pressure sensor layer 151a, and the viscoelastic layer 151b that is provided in contact with the surface, of the pressure sensor layer 151a, on the side opposite to the first end part 131. In the present embodiment, further, the pressure distribution sensor 152 includes the pressure sensor layer 152a, and is provided with no viscoelastic layer like the viscoelastic layer 151b on the surface of the pressure distribution sensor 152. This makes it possible to cause the shift amount of the center position P1 and the shift amount of the center position P2 to be different from each other when the object-to-be-gripped 200 is lifted by the robot hand part 130. This makes it possible to derive the shear force on the basis of, for example, the pressure distribution data obtained from the pressure distribution sensor 151 and the pressure distribution data obtained from the pressure distribution sensor 152. As a result, it is possible to determine whether or not it is possible to hold the object-to-be-gripped 200 without slipping on the basis of a magnitude of the shear force. Accordingly, it is possible to achieve the sensor element 150 having high sensitivity.

In the present embodiment, the control signal that controls the driving of the robot hand part 130 is generated on the basis of the pressure distribution data obtained from the pressure distribution sensor 151 and the pressure distribution data obtained from the pressure distribution sensor 152, and the generated control signal is outputted to the driver 120. This makes it possible to derive the shear force on the basis of, for example, the pressure distribution data obtained from the pressure distribution sensor 151 and the pressure distribution data obtained from the pressure distribution sensor 152. As a result, it is possible to determine whether or not it is possible to hold the object-to-be-gripped 200 without slipping on the basis of a magnitude of the shear force. Accordingly, it is possible to control the robot hand part 130 with high sensitivity.

### 2. MODIFICATION EXAMPLES

Next, modification examples of the robotic apparatus 100 according to the above-described embodiment will be described.

### Modification Example A

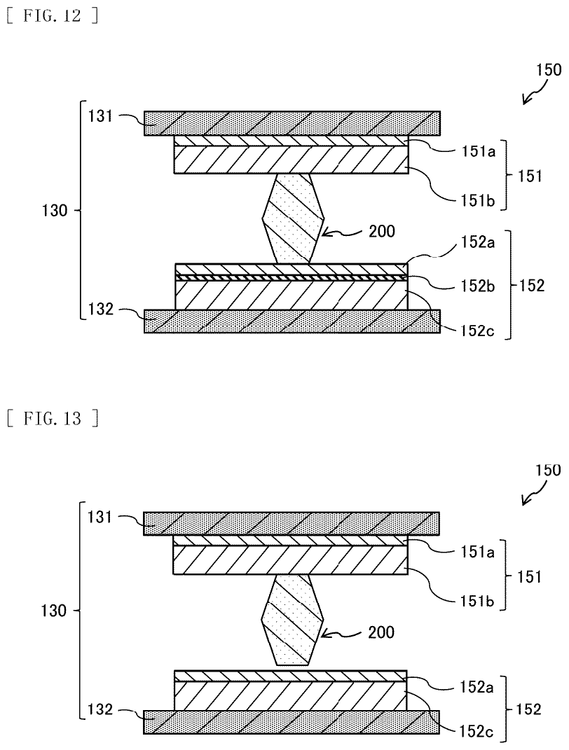

FIG. 12 illustrates a modification example of a cross-sectional configuration of the sensor element 150 to be mounted on the robotic apparatus 100 according to the above-described embodiment. In the present modification example, a viscoelastic layer 152c that deforms by an external load and a rigid layer 152b having rigidity higher than rigidity of the viscoelastic layer 152c are provided between the pressure sensor layer 152a and the second end part 132. The viscoelastic layer 152c corresponds to a specific example of a “second viscoelastic layer” according to the present disclosure. The rigid layer 152b corresponds to a specific example of a “rigid layer” of the present disclosure.

The viscoelastic layer 152c is provided in contact with a surface of the second end part 132. The viscoelastic layer 152c includes a material that deforms by an external load. The viscoelastic layer 152c includes a viscoelastic material having a viscoelastic characteristic such as a silicone gel, a urethane gel, or an acrylic gel, for example. The viscoelastic layer 152c may include, for example, a low-hardness rubber. The viscoelastic layer 152c has a thickness of, for example, less than or equal to 1 mm. The viscoelastic layer 152c has a hardness of, for example, less than or equal to 10° in terms of Durometer A (Shore A). The penetration of the viscoelastic layer 152c is, for example, greater than or equal to 1 in the penetration test method standardized by JIS K2207.

The rigid layer 152b is provided between the pressure sensor layer 152a and the viscoelastic layer 152c. The rigid layer 152b includes, for example, a thin film of a metal such as Al.

Providing the viscoelastic layer 152c below the pressure sensor layer 152a as described above makes it possible to cause respective displacement amounts of the first end part 131 and the second end part 132 with respect to the object-to-be-gripped 200 to be approximately the same when the object-to-be-gripped 200 is lifted by the robot hand part 130. As a result, it is possible to suppress a change in an attitude of the object-to-be-gripped 200. Further, providing the rigid layer 152b between the pressure sensor layer 152a and the viscoelastic layer 152c makes it possible to suppress deformation of the viscoelastic layer 152c. As a result, it is possible to improve mechanical reliability of the pressure sensor layer 152a.

It is to be noted that, in the present modification example, the rigid layer 152b may be omitted as illustrated in FIG. 13 in a case where the mechanical reliability of the pressure sensor layer 152a is less likely to be impaired due to the deformation of the viscoelastic layer 152c.

### Modification Example B

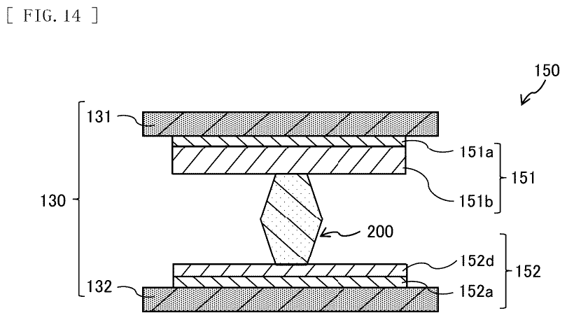

FIG. 14 illustrates a modification example of the cross-sectional configuration of the sensor element 150 to be mounted on the robotic apparatus 100 according to the above-described embodiment and the modification examples thereof. In the present modification example, a protective layer 152d that protects the pressure sensor layer 152a is provided. The protective layer 152d is in contact with a surface, of the pressure sensor layer 152a, on a side of the pressure distribution sensor 151. The protective layer 152d includes, for example, a thin-film rubber that is smaller in thickness than the viscoelastic layer 151b. Providing the protective layer 152d that protects the pressure sensor layer 152a as described above makes it possible to improve the mechanical reliability of the pressure sensor layer 152a.

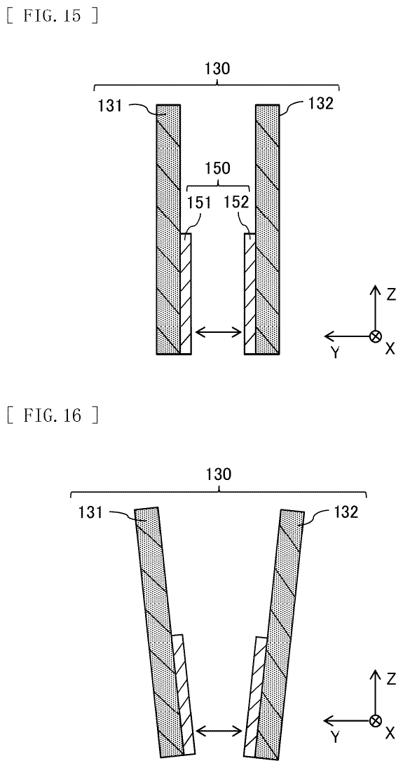

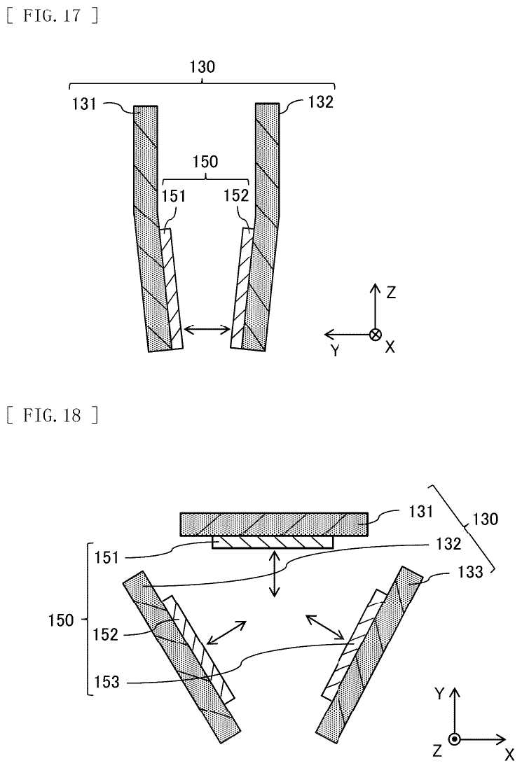

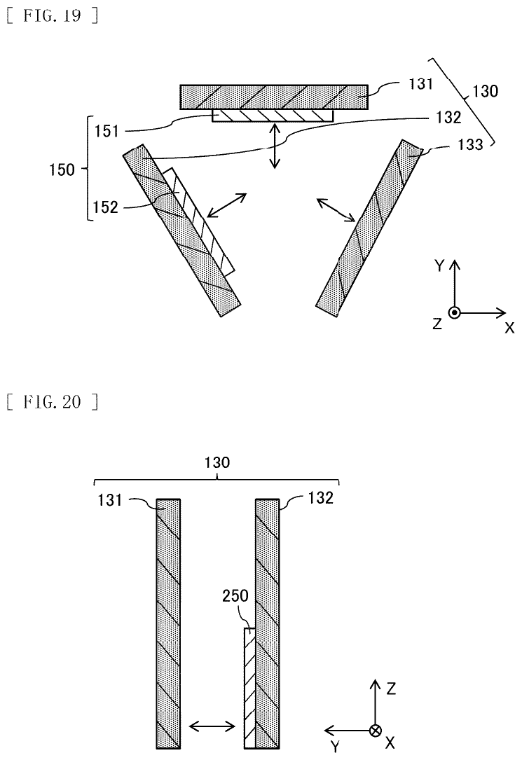

Incidentally, in the above-described embodiment and the modification examples thereof, the sensor element 150 may be bonded only to each of ends of the end parts (the first end part 131 and the second end part 132) of the robot hand part 130, as illustrated in FIGS. 15 and 16, for example. Further, in the above-described embodiment and the modification examples thereof, the end parts (the first end part 131 and the second end part 132) of the robot hand part 130 may be disposed to be parallel to each other with a predetermined gap therebetween, as illustrated in FIG. 15, for example. Further, in the above-described embodiment and the modification examples thereof, the end parts (the first end part 131 and the second end part 132) of the robot hand part 130 may be configured in such a manner that the gap between the first end part 131 and the second end part 132 is tapered, as illustrated in FIGS. 16 and 17, for example.

### Modification Example C

FIG. 18 illustrates a modification example of a cross-sectional configuration of the robot hand part 130 and the sensor element 150 to be mounted on the robotic apparatus 100 according to the above-described embodiment and the modification examples thereof. FIG. 18 exemplifies a horizontal cross section of the robot hand part 130 and the sensor element 150. In the above-described embodiment and the modification examples thereof, the number of end parts of the robot hand part 130 may be three or more. In this case, for example, as illustrated in FIG. 18, the plurality of end parts is disposed in such a manner so as to surround a predetermined region in a horizontal plane. The robot hand part 130 grips the object-to-be-gripped 200 by moving the plurality of end parts closer to the predetermined region. Further, the robot hand part 130 also releases the gripped object-to-be-gripped 200 by moving the plurality of end parts away from the predetermined region.

The sensor element 150 may include one pressure distribution sensor for each end part of the robot hand part 130. For example, in a case where the robot hand part 130 includes three end parts as illustrated in FIG. 18, the sensor element 150 may include three pressure distribution sensors 151, 152, and 153. In this case, the pressure distribution sensor 153 may have a configuration common to the pressure distribution sensor 151, or the pressure distribution sensor 152.

In the present modification example, in a case where the robot hand part 130 includes three or more end parts, for example, as illustrated in FIG. 19, only at least two end parts out of the plurality of end parts of the robot hand part 130 may each be provided with the pressure distribution sensor. In this case, the end part provided with no pressure distribution sensor takes a role of supporting the object-to-be-gripped 200.

### Modification Example D

In the robotic apparatus 100 according to the above-described embodiment, the sensor element 250 may be provided instead of the sensor element 150. Even in such a case, it is possible to control the robot hand part 130 with sufficient sensitivity.

Although the disclosure is described hereinabove with reference to the example embodiments, these embodiments are not to be construed as limiting the scope of the disclosure and may be modified in a wide variety of ways. It should be appreciated that the effects described herein are mere examples. Effects of an example embodiment and modification examples of the disclosure are not limited to those described herein. The disclosure may further include any effects other than those described herein.

Moreover, the present disclosure may have the following configurations.

(1)

A sensor device including:
a first pressure distribution sensor disposed in contact with a first support; and
a second pressure distribution sensor disposed in contact with a second support, in which
respective shift amounts of the first pressure distribution sensor and the second pressure distribution sensor are different from each other, each of the shift amounts being a difference between
   a center position of a pressure distribution to be detected due to gripping of an object-to-be-gripped based on when the object-to-be-gripped in a placed state is gripped by the first support and the second support and
   a center position of a pressure distribution to be detected due to gripping of the object-to-be-gripped based on when the object-to-be-gripped is gripped and lifted by the first support and the second support.
      (2)

The sensor device according to (1), in which
the first pressure distribution sensor includes a first pressure sensor layer that detects an in-plane pressure distribution, and a first viscoelastic layer that is provided in contact with a surface, of the first pressure sensor layer, on a side opposite to the first support, and that deforms by an external load, and
the second pressure distribution sensor includes a second pressure sensor layer that detects an in-plane pressure distribution.
   (3)

The sensor device according to (2), in which
the second pressure distribution sensor further includes, between the second support and the second pressure sensor layer, a second viscoelastic layer that deforms by an external load and a rigid layer having rigidity higher than rigidity of the second viscoelastic layer.
   (4)

The sensor device according to (2), in which
the second pressure distribution sensor further includes a protective layer that is provided in contact with a surface, of the second pressure sensor layer, on a side opposite to the second support.
   (5)

A robotic apparatus including:
a robot hand part;
a driver that drives the robot hand part;
a sensor device provided in contact with the robot hand part; and
a signal processor that processes a detection signal of the sensor device, in which
the robot hand part includes a plurality of end parts configured to grip an object-to-be-gripped by being driven by the driver,
the sensor device includes
   a first pressure distribution sensor that is disposed in contact with a first end part out of the plurality of end parts, and detects an in-plane pressure distribution, and
   a second pressure distribution sensor that is disposed in contact with a second end part out of the plurality of end parts, and detects an in-plane pressure distribution, and
respective shift amounts of the first pressure distribution sensor and the second pressure distribution sensor are different from each other, each of the shift amounts being a difference between
   a center position of a pressure distribution to be detected due to gripping of the object-to-be-gripped based on when the object-to-be-gripped in a placed state is gripped by the plurality of end parts, and
   a center position of a pressure distribution to be detected due to gripping of the object-to-be-gripped based on when the object-to-be-gripped is gripped and lifted by the plurality of end parts.
      (6)

The robotic apparatus according to (5), in which the signal processor generates, on a basis of at least first pressure distribution data obtained from the first pressure distribution sensor and second pressure distribution data obtained from the second pressure distribution sensor, a control signal that controls driving of the robot hand part, and outputs the control signal to the driver.

(7)

The robotic apparatus according to (5) or (6), in which
the first pressure distribution sensor includes a first pressure sensor layer that detects an in-plane pressure distribution, and a first viscoelastic layer that is provided in contact with a surface, of the first pressure sensor layer, on a side opposite to the first end part, and that deforms by an external load, and
the second pressure distribution sensor includes a second pressure sensor layer that detects an in-plane pressure distribution.
   (8)

A robotic apparatus including:
a robot hand part;
a driver that drives the robot hand part;
a sensor device provided in contact with the robot hand part; and
a signal processor that processes a detection signal of the sensor device, in which
the robot hand part includes a plurality of end parts configured to grip an object-to-be-gripped by being driven by the driver,
the sensor device includes a stack in which a first pressure distribution sensor that detects an in-plane pressure distribution, a viscoelastic layer that deforms by an external load, and a second pressure distribution sensor that detects an in-plane pressure distribution are stacked in this order on a first end part out of plurality of end parts, and
respective shift amounts of the first pressure distribution sensor and the second pressure distribution sensor are different from each other, each of the shift amounts being a difference between
   a center position of a pressure distribution to be detected due to gripping of the object-to-be-gripped based on when the object-to-be-gripped in a placed state is gripped by the plurality of end parts, and
   a center position of a pressure distribution to be detected due to gripping of the object-to-be-gripped based on when the object-to-be-gripped is gripped and lifted by the plurality of end parts.
      (9)

The robotic apparatus according to (8), in which the signal processor generates, on a basis of at least first pressure distribution data obtained from the first pressure distribution sensor and second pressure distribution data obtained from the second pressure distribution sensor, a control signal that controls driving of the robot hand part, and outputs the control signal to the driver.

(10)

A sensor device including:
a first pressure distribution sensor disposed in contact with a first support; and
a second pressure distribution sensor disposed in contact with a second support, in which
a shear force to be generated in the first pressure distribution sensor and a shear force to be generated in the second pressure distribution sensor based on when an object-to-be-gripped is gripped and lifted by the first support and the second support are different from each other.
   (11)

A robotic apparatus including:
a robot hand part;
a driver that drives the robot hand part;
a sensor device provided in contact with the robot hand part; and
a signal processor that processes a detection signal of the sensor device, in which
the robot hand part includes a plurality of end parts configured to grip an object-to-be-gripped by being driven by the driver,
the sensor device includes
   a first pressure distribution sensor that is disposed in contact with a first end part out of the plurality of end parts, and detects an in-plane pressure distribution, and
   a second pressure distribution sensor that is disposed in contact with a second end part out of the plurality of end parts, and detects an in-plane pressure distribution, and
a shear force to be generated in the first pressure distribution sensor and a shear force to be generated in the second pressure distribution sensor based on when the object-to-be-gripped is gripped and lifted by the plurality of end parts are different from each other.
   (12)

A robotic apparatus including:
a robot hand part;
a driver that drives the robot hand part;
a sensor device provided in contact with the robot hand part; and
a signal processor that processes a detection signal of the sensor device, in which
the robot hand part includes a plurality of end parts configured to grip an object-to-be-gripped by being driven by the driver,
the sensor device includes a stack in which a first pressure distribution sensor that detects an in-plane pressure distribution, a viscoelastic layer that deforms by an external load, and a second pressure distribution sensor that detects an in-plane pressure distribution are stacked in this order on a first end part out of plurality of end parts, and
a shear force to be generated in the first pressure distribution sensor and a shear force to be generated in the second pressure distribution sensor based on when the object-to-be-gripped is gripped and lifted by the plurality of end parts are different from each other.

According to the sensor device of the embodiment of the present disclosure, the first robotic apparatus of the embodiment of the present disclosure, and the second robotic apparatus of the embodiment of the present disclosure, the respective shift amounts of the first pressure distribution sensor and the second pressure distribution sensor are different from each other. Each of the shift amounts is the difference between the first center position and the second center position. This makes it possible to derive a shear force on the basis of first pressure distribution data obtained from the first pressure distribution sensor and second pressure distribution data obtained from the second pressure distribution sensor. As a result, it is possible to determine whether or not it is possible to hold the object-to-be-gripped without slipping on the basis of a magnitude of the shear force. Accordingly, it is possible to achieve the sensor device having high sensitivity. It is to be noted that the effects of the present disclosure are not necessarily limited to the effects described herein, and may be any effects described herein.

This application claims the benefit of Japanese Priority Patent Application JP2021-043152 filed with the Japan Patent Office on Mar. 17, 2021, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A sensor device comprising:
a first pressure distribution sensor disposed in contact with a first support; and
a second pressure distribution sensor disposed in contact with a second support, wherein
respective shift amounts of the first pressure distribution sensor and the second pressure distribution sensor are different from each other, each of the shift amounts being a difference between
a center position of a pressure distribution to be detected due to gripping of an object-to-be-gripped based on when the object-to-be-gripped in a placed state is gripped by the first support and the second support and
a center position of a pressure distribution to be detected due to gripping of the object-to-be-gripped based on when the object-to-be-gripped is gripped and lifted by the first support and the second support.

2. The sensor device according to claim 1, wherein
the first pressure distribution sensor includes a first pressure sensor layer that detects an in-plane pressure distribution, and a first viscoelastic layer that is provided in contact with a surface, of the first pressure sensor layer, on a side opposite to the first support, and that deforms by an external load, and
the second pressure distribution sensor includes a second pressure sensor layer that detects an in-plane pressure distribution.

3. The sensor device according to claim 2, wherein
the second pressure distribution sensor further includes, between the second support and the second pressure sensor layer, a second viscoelastic layer that deforms by an external load and a rigid layer having rigidity higher than rigidity of the second viscoelastic layer.

4. The sensor device according to claim 2, wherein
the second pressure distribution sensor further includes a protective layer that is provided in contact with a surface, of the second pressure sensor layer, on a side opposite to the second support.

5. A robotic apparatus comprising:
a robot hand part;
a driver that drives the robot hand part;
a sensor device provided in contact with the robot hand part; and
a signal processor that processes a detection signal of the sensor device, wherein the robot hand part includes a plurality of end parts configured to grip an object-to-be-gripped by being driven by the driver,
the sensor device includes
a first pressure distribution sensor that is disposed in contact with a first end part out of the plurality of end parts, and detects an in-plane pressure distribution, and
a second pressure distribution sensor that is disposed in contact with a second end part out of the plurality of end parts, and detects an in-plane pressure distribution, and
respective shift amounts of the first pressure distribution sensor and the second pressure distribution sensor are different from each other, each of the shift amounts being a difference between
a center position of a pressure distribution to be detected due to gripping of the object-to-be-gripped based on when the object-to-be-gripped in a placed state is gripped by the plurality of end parts, and
a center position of a pressure distribution to be detected due to gripping of the object-to-be-gripped based on when the object-to-be-gripped is gripped and lifted by the plurality of end parts.

6. The robotic apparatus according to claim 5, wherein the signal processor generates, on a basis of at least first pressure distribution data obtained from the first pressure distribution sensor and second pressure distribution data obtained from the second pressure distribution sensor, a control signal that controls driving of the robot hand part, and outputs the control signal to the driver.

7. The robotic apparatus according to claim 5, wherein
the first pressure distribution sensor includes a first pressure sensor layer that detects an in-plane pressure distribution, and a first viscoelastic layer that is provided in contact with a surface, of the first pressure sensor layer, on a side opposite to the first end part, and that deforms by an external load, and
the second pressure distribution sensor includes a second pressure sensor layer that detects an in-plane pressure distribution.

8. A robotic apparatus comprising:
a robot hand part;
a driver that drives the robot hand part;
a sensor device provided in contact with the robot hand part; and
a signal processor that processes a detection signal of the sensor device, wherein the robot hand part includes a plurality of end parts configured to grip an object-to-be-gripped by being driven by the driver,
the sensor device includes a stack in which a first pressure distribution sensor that detects an in-plane pressure distribution, a viscoelastic layer that deforms by an external load, and a second pressure distribution sensor that detects an in-plane pressure distribution are stacked in this order on a first end part out of plurality of end parts, and
respective shift amounts of the first pressure distribution sensor and the second pressure distribution sensor are different from each other, each of the shift amounts being a difference between
a center position of a pressure distribution to be detected due to gripping of the object-to-be-gripped based on when the object-to-be-gripped in a placed state is gripped by the plurality of end parts, and
a center position of a pressure distribution to be detected due to gripping of the object-to-be-gripped based on when the object-to-be-gripped is gripped and lifted by the plurality of end parts.

9. The robotic apparatus according to claim 8, wherein the signal processor generates, on a basis of at least first pressure distribution data obtained from the first pressure distribution sensor and second pressure distribution data obtained from the second pressure distribution sensor, a control signal that controls driving of the robot hand part, and outputs the control signal to the driver.
